(19) United States
(12) Patent Application Publication
(10) Pub. No.: US 2015/0086597 A1
(43) Pub. Date: Mar. 26, 2015

(54) ANTIMICROBIAL COPPER OR COPPER ALLOY PRODUCTS AND METHOD FOR MANUFACTURING SAME

(71) Applicants: Joseph MALLAK, Chagrin Falls, OH (US); Lynn TILTON, New York, NY (US); John R. LINTON, JR., Cranberry Township, PA (US); Stephanie BRICKNER, Jefferson Hills, PA (US); Amy MILLER, Baden, PA (US); Mark RODGERS, Pittsburgh, PA (US); Christina ACORS, Monaca, PA (US)

(72) Inventors: Joseph MALLAK, Chagrin Falls, OH (US); Lynn TILTON, New York, NY (US); John R. LINTON, JR., Cranberry Township, PA (US); Stephanie BRICKNER, Jefferson Hills, PA (US); Amy MILLER, Baden, PA (US); Mark RODGERS, Pittsburgh, PA (US); Christina ACORS, Monaca, PA (US)

(21) Appl. No.: 14/497,504

(22) Filed: Sep. 26, 2014

Related U.S. Application Data
(60) Provisional application No. 61/882,885, filed on Sep. 26, 2013.

(51) Int. Cl. A01N 25/34; A01N 59/16; A01N 59/20

(52) U.S. Cl. CPC A01N 25/34; A01N 59/20; A01N 59/16
USPC 424/407; 424/630; 427/207.1; 156/60; 428/457

(57) ABSTRACT

A copper or copper alloy product is provided, as well as a process for manufacturing a copper or copper alloy product. The product may include copper or copper alloy containing a minimum of 60% copper. The product may include an antimicrobial copper, such as, for example, the antimicrobial copper identified by the United States Environmental Protection Agency (EPA). The product may include, but is not limited to, for example, MD-Cu₂₉™ antimicrobial copper or copper alloy. The antimicrobial copper or copper alloy which contains an antimicrobial touch surface should effectively kill bacteria within about two hours of exposure to the bacteria.

### CROSS-REFERENCE TO RELATED APPLICATIONS

This application claims benefit and priority to U.S. Provisional Application No. 61/882,885; filed Sep. 26, 2013, the disclosure of which is incorporated by reference herein in its entirety.

### BACKGROUND

1.0 Field of the Disclosure

The present disclosure is directed generally to a method and apparatus related to an antimicrobial surface and, more particularly, the disclosure is directed to a method and apparatus that provides an antimicrobial surface that includes a copper or copper alloy composition.

2.0 Background

Currently, there exists large variety of strains of antibiotic resistant virulent microbes. The microbes cause diseases such as, e.g., methicillin-resistant staphylococcus aureus (MRSA), that, if left untreated, can lead to sickness and even death. This problem is especially prevalent in settings, e.g., hospital, public schools, elderly homes, and the like, where virulent microbes can easily spread among its inhabitants. There is a need to frequently sanitize and/or disinfect surfaces that people may touch in many environments including homes, hotels, hospitals, places of work, and the like.

There are several types of antimicrobial agents that are currently available. These agents may include, e.g., chemical antimicrobial agents, e.g., disinfectants. However, these chemical antimicrobial agents are often harmful to both the environment and the person coming into contact with them. Also, many of them can lose their antimicrobial activity within a short time period.

There is an unfulfilled need for a novel mechanism that protects every day and specialty surfaces from antimicrobial agents.

### SUMMARY OF THE DISCLOSURE

According to an aspect of the disclosure, a copper or copper alloy product is provided, as well as a process for manufacturing a copper or copper alloy product. The product may include copper or copper alloy containing a minimum of 60% copper. The product may include an antimicrobial copper, such as, for example, the antimicrobial copper identified by the United States Environmental Protection Agency (EPA). The product may include, but is not limited to, for example, MD-Cu₂₉™ antimicrobial copper or copper alloy. The antimicrobial copper or copper alloy which contains an antimicrobial touch surface should effectively kill bacteria within about two hours of exposure to the bacteria.

The product may include a material having a temper that may range from soft to hard.

The product may include any product used in, for example, healthcare care, extended care, residential or commercial facilities, public or private facilities, public or private vehicles, or anywhere else where germs may be transferred through contact of or exposure to a surface.

The products may include, but are not limited to, e.g., a bed or any part thereof (e.g., a bedrail, a footboard, an over-bed table, or the like), a table or any part thereof, a handle or any part thereof (e.g., a knob, a pull bar, a push plate, a pull plate, a fluted knob, a knurled knob, a push/pull knob, a T-handle, a tapered knob, a ball knob, or the like), a handrail, a wall panel, a cart or any part thereof (e.g., a hospital cart, a computer cart, a record cart, a phlebotomy cart, a shopping cart, or the like), a kick plate, a mop plate, a stretcher plate, a sink or any part thereof, a spigot, a drain, a faucet, a drain control lever, a water fountain, a bubbler head, a drain strainer, an alcohol sanitizer dispenser, a paper towel holder, a facial tissue holder, a toilet paper holder, an air hand dryer, a control and/or push button on an air hand dryer, a hydrotherapy tank (e.g., a whirlpool tank), a shell, a cover, a headrest, a grab bar (e.g., in a bathroom shower or bathtub), a panic bar on a door, a towel bar, a showerhead, a countertop, a hinge, a lock, a latch, trim, a floor stop, a protector guard, a toilet, toilet hardware, a urinal, urinal hardware, a lever, a push button, a toilet seat inlay for lifting of seat, a vertical locking arm, a vertical cover guard, a protection bar, a light switch, a switch plate, a chair, an armrest, a chair frame, a thermostat cover, a telephone handset, a keypad, any kitchen surface (where the kitchen surface may include any non-prep food area, so that food does not contact the antimicrobial surface), a microwave handle, a refrigerator handle, a stove handle, a cabinet door, a backsplash, a hood, an appliance control knob, a floor tile, a ceiling tile, a wall tile, an instrument handle, a housing/control/handle for a monitoring system, a stand, a light fixture, an intravenous (IV) pole, a base, a hanger, a clip, a tray, a bedpan, a walker, a wheelchair or any part thereof, a computer or any part thereof, exercise/rehabilitation/physical therapy equipment or any part thereof, a chart holder, clipboard, a shelf (e.g., storage shelf), a child seat or any part thereof, an ATM machine or any part thereof, an elevator or any part thereof, a soap holder or any part thereof, a soap dispenser or any part thereof, a toilet paper dispenser or any part thereof, a window or any part thereof, a light switch or any part thereof, a laundry hamper or any part thereof, a container or canister or any part thereof, a magazine rack, a signage, a coat rack and hook, a shower curtain ring, a radiator cover, a badge clip, a name tag, a vending machine or any part thereof, a gang wall plate (e.g., toggle switch, rocker switch, duplex outlet, or the like, or any combination of the foregoing), a tile (a self-adhesive tile or a grouted tile), a flat sheet for a baby changing table, a toilet brush cleaner, and the like.

According to another aspect of the disclosure, a method is provided for disinfecting or killing bacteria. The method includes providing an antimicrobial copper or copper alloy; forming or making a product using the antimicrobial copper or copper alloy; and providing the product to a location to kill bacteria that may be transferred through surface contact, wherein the antimicrobial copper or copper allow includes at least 60% copper, or the composition values disclosed hereinbelow. Where appropriate, the method may further include affixing the product at the location. The product includes EPA registered antimicrobial copper. The product may include MD-Cu₂₉™ antimicrobial copper or copper alloy. The antimicrobial copper or copper alloy should effectively kill bacteria within about two hours, more or less of contact with the bacteria. The product may be located in any location that is likely to be contacted (or touched) by a person, such as, e.g., a person entering or exiting a space, or while in a space, such as, but not limited to, for example, a hospital room, a bedroom, a bathroom, a meeting room, a utility room, or the like, or a moveable space, such as, but not limited to, for example, a train car, a bus, an automobile, or the like.

According to a further aspect of the disclosure, a method is provided for manufacturing a product according to the principles of the disclosure. The method includes: providing a material including EPA registered antimicrobial copper; forming a product from the provided material using a forming device; optionally applying an adhesive to a surface on a side (e.g., bottom side) of the product; optionally applying a potential protective coating layer to the adhesive layer; and forming the material into a finished product. The applying an adhesive may include applying the adhesive such as, e.g., the material is unrolled from a reel, or further downstream as the material travels to, e.g., a punch press. The step of applying the adhesive may be done after the finished product is formed. This application of the adhesive may be done to a freestanding item as well. The method may further include applying a removable protective coating to a contact surface of the product, which may be removed by the consumer to expose the antimicrobial properties of the product surface.

The forming device may include a punch press, an abrasive waterjet, a die, a manual shearing apparatus (e.g., scissors, or the like), a bender, or the like. The product may be made through any of the following processes, for example, but not limited to, a deep drawing process, an extrusion process, a stamping/cutting process, a cast forging process, a welding process, a brazing/etching process, or the like.

In one aspect, an antimicrobial apparatus may be provided comprising a device configured with a formed antimicrobial copper layer comprising at least 60% copper. The antimicrobial copper layer may be a separate layer formed to match a surface contour of the device. The antimicrobial copper layer may be attached to the device with an adhesive layer. The copper layer comprises a copper alloy. The copper alloy may comprise nickel. The copper alloy may comprise a percentage of nickel selected from the range of about 1% to about 40%. The percentage of nickel may be one of: about 3.8%, about 8.7%, about 27%. The copper alloy may comprise copper being a percentage selected from a range from 60% to about 90%.

In one aspect, a method of disinfecting or killing bacteria, the method comprising: forming a surface for a product using EPA registered antimicrobial copper, comprising at least 60% copper. The method may further comprise the step of shipping the formed surface to be applied to a surface of a device. The method may further comprise the step of applying an adhesive layer to the formed surface. The method may further comprise applying the formed surface to a surface of a device.

Additional features, advantages, and embodiments of the disclosure may be set forth or apparent from consideration of the following attached detailed description and drawing. Moreover, it is to be understood that both the foregoing summary of the disclosure and the following attached detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawing:

FIG. 1 shows a process of making a product, according to the principles of the disclosure;

FIG. 2 shows a process of making a product, according to the principles of the disclosure;

FIG. 3 is a block diagram illustrating a product or device or apparatus constructed according to principles of the disclosure; and

FIG. 4 illustrates a device 310 constructed according to principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following attached description. It should be noted that the features illustrated in the drawing are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise. The term “about” refers to within +/−10%, when referring to a percentage.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The product according to the present disclosure may include, e.g., any of the products mentioned earlier herein.

The product must contain at least 60% copper or copper alloy. A few non-limiting examples of a product that is constructed according the principles of the disclosure include as shown in Table 1 (“other” in Table 1, Table 2 and Table 3 may refer to, e.g., nickel):

TABLE 1

| Product | Composition | | ASTM # |
|---|---|---|---|
| 3.5 × 15 Push Plate Screw On | 96.2% Copper | 3.8% Other | C11000 |
| 3.5 × 15 Push Plate Screw On | 73% Copper | 27.0% Other | C26000 |
| 3.5 × 15 Push Plate Screw On | 91.3% Copper | 8.7% Other | C70600 |
| 3.5 × 15 Push Plate Screw On | 73% Copper | 27.0% Other | C71500 |
| 3.5 × 15 Push Plate Self | 96.2% Copper | 3.8% Other | C11000 |
| Adhesive | | | |
| 3.5 × 15 Push Plate Self | 73% Copper | 27.0% Other | C26000 |
| Adhesive | | | |
| 3.5 × 15 Push Plate Self | 91.3% Copper | 8.7% Other | C70600 |
| Adhesive | | | |
| 3.5 × 15 Push Plate Self | 73% Copper | 27.0% Other | C71500 |
| Adhesive | | | |
| 3.5 × 15 Pull Plate Screw On | 96.2% Copper | 3.8% Other | C11000 |
| 3.5 × 15 Pull Plate Screw On | 73% Copper | 27.0% Other | C26000 |
| 3.5 × 15 Pull Plate Screw On | 91.3% Copper | 8.7% Other | C70600 |
| 3.5 × 15 Pull Plate Screw On | 73% Copper | 27.0% Other | C71500 |
| 4 × 16 Push Plate Screw On | 96.2% Copper | 3.8% Other | C11000 |
| 4 × 16 Push Plate Screw On | 73% Copper | 27.0% Other | C26000 |
| 4 × 16 Push Plate Screw On | 91.3% Copper | 8.7% Other | C70600 |
| 4 × 16 Push Plate Screw On | 73% Copper | 27.0% Other | C71500 |
| 4 × 16 Push Plate Self | 96.2% Copper | 3.8% Other | C11000 |
| Adhesive | | | |
| 4 × 16 Push Plate Self | 73% Copper | 27.0% Other | C26000 |
| Adhesive | | | |
| 4 × 16 Push Plate Self | 91.3% Copper | 8.7% Other | C70600 |
| Adhesive | | | |
| 4 × 16 Push Plate Self | 73% Copper | 27.0% Other | C71500 |
| Adhesive | | | |
| 4 × 16 Pull Plate Screw On | 96.2% Copper | 3.8% Other | C11000 |
| 4 × 16 Pull Plate Screw On | 73% Copper | 27.0% Other | C26000 |
| 4 × 16 Pull Plate Screw On | 91.3% Copper | 8.7% Other | C70600 |
| 4 × 16 Pull Plate Screw On | 73% Copper | 27.0% Other | C71500 |
| 1 Gang Wall Plate Toggle | 96.2% Copper | 3.8% Other | C11000 |
| Switch | | | |
| 1 Gang Wall Plate Toggle | 73% Copper | 27.0% Other | C26000 |
| Switch | | | |
| 1 Gang Wall Plate Toggle | 91.3% Copper | 8.7% Other | C70600 |
| Switch | | | |
| 1 Gang Wall Plate Toggle | 73% Copper | 27.0% Other | C71500 |
| Switch | | | |
| 1 Gang Wall Plate Rocker | 96.2% Copper | 3.8% Other | C11000 |
| Switch | | | |
| 1 Gang Wall Plate Rocker | 73% Copper | 27.0% Other | C26000 |
| Switch | | | |
| 1 Gang Wall Plate Rocker | 91.3% Copper | 8.7% Other | C70600 |
| Switch | | | |
| 1 Gang Wall Plate Rocker | 73% Copper | 27.0% Other | C71500 |
| Switch | | | |
| 1 Gang Wall Plate Duplex | 96.2% Copper | 3.8% Other | C11000 |
| Outlet | | | |
| 1 Gang Wall Plate Duplex | 73% Copper | 27.0% Other | C26000 |
| Outlet | | | |
| 1 Gang Wall Plate Duplex | 91.3% Copper | 8.7% Other | C70600 |
| Outlet | | | |
| 1 Gang Wall Plate Duplex | 73% Copper | 27.0% Other | C71500 |
| Outlet | | | |
| 2 Gang Wall Plate Toggle | 96.2% Copper | 3.8% Other | C11000 |
| Switch | | | |
| 2 Gang Wall Plate Toggle | 73% Copper | 27.0% Other | C26000 |
| Switch | | | |
| 2 Gang Wall Plate Toggle | 91.3% Copper | 8.7% Other | C70600 |
| Switch | | | |
| 2 Gang Wall Plate Toggle | 73% Copper | 27.0% Other | C71500 |
| Switch | | | |
| 2 Gang Wall Plate Rocker | 96.2% Copper | 3.8% Other | C11000 |
| Switch | | | |
| 2 Gang Wall Plate Rocker | 73% Copper | 27.0% Other | C26000 |
| Switch | | | |
| 2 Gang Wall Plate Rocker | 91.3% Copper | 8.7% Other | C70600 |
| Switch | | | |
| 2 Gang Wall Plate Rocker | 73% Copper | 27.0% Other | C71500 |
| Switch | | | |
| 2 Gang Wall Plate Duplex | 96.2% Copper | 3.8% Other | C11000 |
| Outlet | | | |
| 2 Gang Wall Plate Duplex | 73% Copper | 27.0% Other | C26000 |
| Outlet | | | |
| 2 Gang Wall Plate Duplex | 91.3% Copper | 8.7% Other | C70600 |
| Outlet | | | |
| 2 Gang Wall Plate Duplex | 73% Copper | 27.0% Other | C71500 |
| Outlet | | | |
| 2 Gang Wall Plate Toggle | 96.2% Copper | 3.8% Other | C11000 |
| Switch/Rocker Switch | | | |
| 2 Gang Wall Plate Toggle | 73% Copper | 27.0% Other | C26000 |
| Switch/Rocker Switch | | | |
| 2 Gang Wall Plate Toggle | 91.3% Copper | 8.7% Other | C70600 |
| Switch/Rocker Switch | | | |
| 2 Gang Wall Plate Toggle | 73% Copper | 27.0% Other | C71500 |
| Switch/Rocker Switch | | | |
| 2 Gang Wall Plate Toggle | 96.2% Copper | 3.8% Other | C11000 |
| Switch/Duplex Outlet | | | |
| 2 Gang Wall Plate Toggle | 73% Copper | 27.0% Other | C26000 |
| Switch/Duplex Outlet | | | |
| 2 Gang Wall Plate Toggle | 91.3% Copper | 8.7% Other | C70600 |
| Switch/Duplex Outlet | | | |
| 2 Gang Wall Plate Toggle | 73% Copper | 27.0% Other | C71500 |
| Switch/Duplex Outlet | | | |
| 2 Gang Wall Plate Rocker | 96.2% Copper | 3.8% Other | C11000 |
| Switch/Duplex Outlet | | | |
| 2 Gang Wall Plate Rocker | 73% Copper | 27.0% Other | C26000 |
| Switch/Duplex Outlet | | | |
| 2 Gang Wall Plate Rocker | 91.3% Copper | 8.7% Other | C70600 |
| Switch/Duplex Outlet | | | |
| 2 Gang Wall Plate Rocker | 73% Copper | 27.0% Other | C71500 |
| Switch/Duplex Outlet | | | |
| Self Adhesive Tile | 96.2% Copper | 3.8% Other | C11000 |
| Self Adhesive Tile | 73% Copper | 27.0% Other | C26000 |
| Self Adhesive Tile | 91.3% Copper | 8.7% Other | C70600 |
| Self Adhesive Tile | 73% Copper | 27.0% Other | C71500 |
| Grouted Tile | 96.2% Copper | 3.8% Other | C11000 |
| Grouted Tile | 73% Copper | 27.0% Other | C26000 |
| Grouted Tile | 91.3% Copper | 8.7% Other | C70600 |
| Grouted Tile | 73% Copper | 27.0% Other | C71500 |
| Round 17 × 7 Single Wall | 96.2% Copper | 3.8% Other | C11000 |
| Drop In Sink | | | |
| Round 17 × 7 Single Wall | 73% Copper | 27.0% Other | C26000 |
| Drop In Apron Sink | | | |
| Round 17 × 8 Double Wall | 91.3% Copper | 8.7% Other | C70600 |
| Sink | | | |
| Oval 19 × 14 × 5 Scallop | 73% Copper | 27.0% Other | C71500 |
| Drop In Sink | | | |

The product may include copper, brass, copper-nickel, or the like. The product must contain at least 60% copper or copper alloy. The product includes EPA registered antimicrobial copper.

A few non-limiting examples of a product that is constructed according to the principles of the disclosure include:

TABLE 2

| | | | | | | |
|---|---|---|---|---|---|---|
| Bar Sinks | 96.2% | 3.8% | 73% | 27.0% | 91.3% | 8.7% |
| | Copper | Other | Copper | Other | Copper | Other |
| Kitchen/Bathroom | 96.2% | 3.8% | 73% | 27.0% | 91.3% | 8.7% |
| Sinks | Copper | Other | Copper | Other | Copper | Other |
| Refrigerator Pulls | 96.2% | 3.8% | 73% | 27.0% | 91.3% | 8.7% |
| | Copper | Other | Copper | Other | Copper | Other |
| Over the bed table | 96.2% | 3.8% | 73% | 27.0% | 91.3% | 8.7% |
| (top) for hospitals | Copper | Other | Copper | Other | Copper | Other |
| Microwave pulls | 96.2% | 3.8% | 73% | 27.0% | 91.3% | 8.7% |
| | Copper | Other | Copper | Other | Copper | Other |
| Kick Plates | 96.2% | 3.8% | 73% | 27.0% | 91.3% | 8.7% |
| | Copper | Other | Copper | Other | Copper | Other |
| Flat sheet for baby | 96.2% | 3.8% | 73% | 27.0% | 91.3% | 8.7% |
| changing tables | Copper | Other | Copper | Other | Copper | Other |
| copper flooring | 96.2% | 3.8% | 73% | 27.0% | 91.3% | 8.7% |
| | Copper | Other | Copper | Other | Copper | Other |
| Soap Dispensers | 96.2% | 3.8% | 73% | 27.0% | 91.3% | 8.7% |
| | Copper | Other | Copper | Other | Copper | Other |
| Toilet Brush | 96.2% | 3.8% | 73% | 27.0% | 91.3% | 8.7% |
| Cleaner | Copper | Other | Copper | Other | Copper | Other |
| Over-bed tables | 96.2% | 3.8% | 73% | 27.0% | 91.3% | 8.7% |
| | Copper | Other | Copper | Other | Copper | Other |
| Bed-side tables | 96.2% | 3.8% | 73% | 27.0% | 91.3% | 8.7% |
| | Copper | Other | Copper | Other | Copper | Other |
| Equipment carts | 96.2% | 3.8% | 73% | 27.0% | 91.3% | 8.7% |
| | Copper | Other | Copper | Other | Copper | Other |
| Sinks | 96.2% | 3.8% | 73% | 27.0% | 91.3% | 8.7% |
| | Copper | Other | Copper | Other | Copper | Other |
| Water fountains | 96.2% | 3.8% | 73% | 27.0% | 91.3% | 8.7% |
| | Copper | Other | Copper | Other | Copper | Other |
| Hydrotherapy tanks | 96.2% | 3.8% | 73% | 27.0% | 91.3% | 8.7% |
| | Copper | Other | Copper | Other | Copper | Other |
| Door handles, | 96.2% | 3.8% | 73% | 27.0% | 91.3% | 8.7% |
| doorknobs | Copper | Other | Copper | Other | Copper | Other |
| Countertops and | 96.2% | 3.8% | 73% | 27.0% | 91.3% | 8.7% |
| tabletops | Copper | Other | Copper | Other | Copper | Other |
| Chair: armrests | 96.2% | 3.8% | 73% | 27.0% | 91.3% | 8.7% |
| | Copper | Other | Copper | Other | Copper | Other |
| Table tops, counter | 96.2% | 3.8% | 73% | 27.0% | 91.3% | 8.7% |
| tops, handles | Copper | Other | Copper | Other | Copper | Other |
| Wall tiles | 96.2% | 3.8% | 73% | 27.0% | 91.3% | 8.7% |
| | Copper | Other | Copper | Other | Copper | Other |
| Trays | 96.2% | 3.8% | 73% | 27.0% | 91.3% | 8.7% |
| | Copper | Other | Copper | Other | Copper | Other |
| Computer | 96.2% | 3.8% | 73% | 27.0% | 91.3% | 8.7% |
| keyboards: | Copper | Other | Copper | Other | Copper | Other |
| Laundry hampers, | 96.2% | 3.8% | 73% | 27.0% | 91.3% | 8.7% |
| trash canisters, and | Copper | Other | Copper | Other | Copper | Other |
| other containers | | | | | | |
| Soap holder | 96.2% | 3.8% | 73% | 27.0% | 91.3% | 8.7% |
| | Copper | Other | Copper | Other | Copper | Other |
| Pens | 96.2% | 3.8% | 73% | 27.0% | 91.3% | 8.7% |
| | Copper | Other | Copper | Other | Copper | Other |
| Electrical wall | 96.2% | 3.8% | 73% | 27.0% | 91.3% | 8.7% |
| plates | Copper | Other | Copper | Other | Copper | Other |
| Water dispensers | 96.2% | 3.8% | 73% | 27.0% | 91.3% | 8.7% |
| | Copper | Other | Copper | Other | Copper | Other |
| Soap dispenser | 96.2% | 3.8% | 73% | 27.0% | 91.3% | 8.7% |
| | Copper | Other | Copper | Other | Copper | Other |
| Electrical wall | 96.2% | 3.8% | 73% | 27.0% | 91.3% | 8.7% |
| plates | Copper | Other | Copper | Other | Copper | Other |
| Handrails | 96.2% | 3.8% | 73% | 27.0% | 91.3% | 8.7% |
| | Copper | Other | Copper | Other | Copper | Other |
| Air circulation | 96.2% | 3.8% | 73% | 27.0% | 91.3% | 8.7% |
| products | Copper | Other | Copper | Other | Copper | Other |
| Sports equipment | 96.2% | 3.8% | 73% | 27.0% | 91.3% | 8.7% |
| | Copper | Other | Copper | Other | Copper | Other |
| Personal care items | 96.2% | 3.8% | 73% | 27.0% | 91.3% | 8.7% |
| | Copper | Other | Copper | Other | Copper | Other |
| Toilet Brush | 96.2% | 3.8% | 73% | 27.0% | 91.3% | 8.7% |
| Cleaner | Copper | Other | Copper | Other | Copper | Other |
| Toilet Flusher | 96.2% | 3.8% | 73% | 27.0% | 91.3% | 8.7% |
| Handle | Copper | Other | Copper | Other | Copper | Other |

The product may include the following further attributes:

TABLE 3
Cabinet Pulls

| LENGTH | HEIGHT | | | | |
|---|---|---|---|---|---|
| cm/in. | cm/in. | Composition | | | |
| 12.40/4.88 | 3.10/1.22 | 73% | 27.0% | 91.3% | 8.7% |
| | | Copper | Other | Copper | Other |
| 15.60/6.14 | 3.10/1.22 | 73% | 27.0% | 91.3% | 8.7% |
| | | Copper | Other | Copper | Other |
| 18.80/7.40 | 3.10/1.22 | 73% | 27.0% | 91.3% | 8.7% |
| | | Copper | Other | Copper | Other |
| 22.00/8.66 | 3.10/1.22 | 73% | 27.0% | 91.3% | 8.7% |
| | | Copper | Other | Copper | Other |
| 25.20/9.92 | 3.10/1.22 | 73% | 27.0% | 91.3% | 8.7% |
| | | Copper | Other | Copper | Other |
| 31.60/12.44 | 3.10/1.22 | 73% | 27.0% | 91.3% | 8.7% |
| | | Copper | Other | Copper | Other |
| 12.20/4.80 | 3.60/1.42 | 73% | 27.0% | 91.3% | 8.7% |
| | | Copper | Other | Copper | Other |
| 15.50/6.10 | 3.60/1.42 | 73% | 27.0% | 91.3% | 8.7% |
| | | Copper | Other | Copper | Other |
| 18.60/7.32 | 3.60/1.42 | 73% | 27.0% | 91.3% | 8.7% |
| | | Copper | Other | Copper | Other |
| 10.50/4.13 | 3.50/1.38 | 73% | 27.0% | 91.3% | 8.7% |
| | | Copper | Other | Copper | Other |
| 13.75/5.41 | 3.50/1.38 | 73% | 27.0% | 91.3% | 8.7% |
| | | Copper | Other | Copper | Other |
| 16.95/6.67 | 3.50/1.38 | 73% | 27.0% | 91.3% | 8.7% |
| | | Copper | Other | Copper | Other |
| 20.15/7.93 | 3.50/1.38 | 73% | 27.0% | 91.3% | 8.7% |
| | | Copper | Other | Copper | Other |
| 10.66/4.20 | 3.20/1.26 | 73% | 27.0% | 91.3% | 8.7% |
| | | Copper | Other | Copper | Other |
| 13.89/5.47 | 3.20/1.26 | 73% | 27.0% | 91.3% | 8.7% |
| | | Copper | Other | Copper | Other |
| 17.06/6.72 | 3.20/1.26 | 73% | 27.0% | 91.3% | 8.7% |
| | | Copper | Other | Copper | Other |
| 20.29/7.99 | 3.20/1.26 | 73% | 27.0% | 91.3% | 8.7% |
| | | Copper | Other | Copper | Other |

The product may include, for example, but is not limited to MD-Cu₂₉™ antimicrobial copper or copper alloy. The antimicrobial copper or copper alloy should effectively kill bacteria within about two hours of exposure to the bacteria such as, for example, but not limited to Staphylococcus aureus, Enterobacter aerogenes, Methicillin-Resistant Staphylococcus aureus (MRSA), Escherichia coli O157:H7, Pseudomonas aeruginosa and, Vancomycin-Resistant Enterococcus faecalis (VRE).

The antimicrobial copper or copper alloy may kill about 99.9% or more of, for example, the bacteria listed above, within about two hours of contacting (or being infected by) the bacteria. If scratched, the area where scratched will remain antimicrobial.

The product may include a material having a temper that may range from soft to hard.

The product may have the afore-noted dimensions and compositions.

The product may include an adhesive layer that is provided on a portion of, or an entire surface of a side of a product. The product may further include a barrier layer, such as, e.g., a plastic, that is affixed to the adhesive layer. The barrier layer may be removed (e.g., peeled away) from the product to expose the adhesive layer, which may then be used to adhere the product to a surface, such as, a portion of, e.g., a floor, a wall, a door, a window, a furniture item, an appliance, or the like.

The product may further include a removable protective coating to a contact surface of the product, which may be removed by the consumer to expose the antimicrobial properties of the product surface.

According to another aspect of the present disclosure, a method is provided for plating an existing product with an EPA registered antimicrobial copper or copper alloy. The copper or copper alloy should contain a minimum of 60% copper. The copper content may be less than 99%. The percentage of copper may be one of: about 73%, about 91.3% and about 96.2%. In this regard, the thickness of the copper plating should be sufficient to withstand scratches, or other damage to the plating that may result in penetration of the entire thickness of the plating.

According to another aspect of the present disclosure, a method is provided for creating a product with copper or copper alloy that contains a minimum of 60% copper through die casting method. This copper or copper alloy may include EPA registered antimicrobial copper.

According to an aspect of the disclosure, a method is provided for killing bacteria in areas that may involve contact with the bacteria. The method includes: providing a material including EPA registered antimicrobial copper; forming a product from the provided material using a forming device; optionally, applying an adhesive to a surface on a side (e.g., bottom side) of the product; optionally, applying a potential protective coating layer to the adhesive layer; and forming the material into a finished product. The applying an adhesive may include applying the adhesive as, e.g., the material is unrolled from a reel, or further downstream as the material travels to, e.g., a punch press. The step of applying the adhesive may be done after the finished product is formed. This application of the adhesive may be done to a freestanding item as well. The method may further include applying a removable protective coating to a contact surface of the product, which may be removed by the consumer to expose the antimicrobial properties of the product surface. The antimicrobial copper or copper alloy should effectively kill many species of bacteria within, for example, about two hours, or less (or more) of contact with the bacteria. The product may be located anywhere where it is likely to be contacted (or touched) by a person, such as, but not limited to, for example, healthcare care, extended care, residential or commercial facilities, public or private facilities, public or private vehicles, or anywhere else where germs may be transferred through contact of or exposure to a surface.

The product may include, for example, but is in no way limited to the following:

### Healthcare Facilities

Bedrails, footboards
Over-bed tables
Bed-side tables in hospitals, extended care facilities, senior housing etc. (knobs, pulls, handles; surfaces)
Handrails, (corridor/hallways) (Senior housing), automatic door push plates
Stair rails, handrails, tubular railing, and supports, rail fittings T's, elbows and brackets
Bedrails, assistance rails
Toilet safety rails
Carts
Hospital carts (table surfaces, handles, legs)
Computer carts
Record carts
Phlebotomy carts
Other Carts (tables/surfaces, shelving, railings, handles, pulls)
Equipment carts (horizontal surfaces, frames, handles)
Door push plates, kick plates, mop plates, stretcher plates
Sinks: spigots, drains, sinks themselves
Faucet: handles, spigot, drain control lever
Water fountains: bubbler head, drain strainer, handle
Alcohol sanitizer dispenser, handle
Paper towel holders, facial tissue holders, toilet paper holders
Air hand dryer, controls and push buttons on air hand dryers
Hydrotherapy tanks (whirlpool tanks): shells, covers, headrests, drain fittings (outer surfaces without water contact)
Door handles, doorknobs (outer touch surfaces)
Grab bars in bathrooms showers and bathtubs
Panic bars on emergency room doors
Towel bars
Showerheads
Countertops and tabletops (non-food use only)
Hinges, locks, latches, and trim
Door stops, door pulls, and protector guards
Toilet and urinal hardware, levers, push buttons
Toilet seat inlay for lifting of seat
Closures
Vertical locking arms
Vertical cover guards
Protection bars
Light switches, switch plates
Visitor chairs: armrests, metal frames
Thermostat covers, control knobs and wheels
Telephone handsets and surfaces (housings), keypad
Kitchen surfaces (non-food contact only): table tops, counter tops, handles (microwave, refrigerator, stove), cabinet doors, cabinet hinges, pulls, backsplash, hoods, control knobs (appliances, fans)
Floor tiles
Ceiling tiles (non-porous)
Wall tiles
Instrument handles

### Medical Equipment Knobs, Pulls and Handles for:

Drug delivery systems
Monitoring systems
Hospital beds
Office equipment
Operating room equipment
Stands and fixtures

### Types of Knobs: e.g., Prong, Fluted, Knurled, Push/Pull, T-Handle, Tapered, and Ball Knobs

Intravenous (IV) poles, bases, hangers, clips
Trays (instruments, non-food contact)
Pans (bed)
Walkers, wheelchair handles, and tubular components
Computer keyboards: keys, housings, computer mouse surfaces
Exercise and rehabilitation equipment, handles, bars
Physical therapy equipment: physical therapy tables, treatment chairs and portable taping tables
Chairs (shower chairs, patient chairs, visitor chairs): rails, backs, legs, seats
Lighting products: X-ray illuminators, operating rooms, patient examination rooms, surgical suites, and reading lamps for hospital rooms and assisted living facilities etc. Components can include bases, arms, housings, handles, hinges)
Headwall systems: the unit themselves, outlet covers, knobs and dials, lighting units (lamp housings and adjustable arms), CRT monitors with rotating knobs and levers and adjustments. Baskets, monitor housings, knobs, baskets, tables, IV poles
Critical care cart: Table top, drawer, drawer pull, lock, copper wire baskets for storage of equipment and charts
Bedside lavatory: sink, faucet, handles, drawer pulls, toilet seat, toilet seat cover, toilet handle, door and cabinet facings, counter tops
Medical records: Chart holders, clipboards, filing systems
Storage Shelving: wire shelving etc. for medical supplies
Grab handles on privacy curtains
Lids of laundry hampers, trash canisters, and other containers
Bedside pitchers
Closet rods and hangers
Television controls: knobs, buttons, remote
Monitor (television, computer, etc.) housing
Cup Holder
Toothbrush holder
Soap holder, dispenser
Magazine rack
Signage
Coat rack and hooks
Shower curtain rings
Radiator cover
Bracelets
Pens
Badge clips
Name tags
Patient gown snaps
Window sills, pulls and locks
Electrical wall plates

### Community Facilities (Including Various Public and Commercial Buildings)

Shopping cart handles, child seats, handrails
Cash registers: housing, keypads
ATM machines: keys, housing
Gym/Health club lockers, locker handles, locker shelving, trainers' tables
Exercise equipment, handles, bars
Ice and water dispensers (outer surfaces without water contact)
Elevator: handrail, control panel, buttons, interior walls, floor tiles, exterior call button plate
Paper towel dispensers. Housing itself, (turn) handle, (push) handle
Soap holder
Soap dispenser (wall mounted): push bar and dispenser itself
Soap dispenser (sitting on counter): dispenser housing itself, push mechanism
Toilet paper dispenser (housing)
Windows (crank), Locking mechanism, pull handles
Window treatments (cord pulls), Venetian blinds (wands, cord pulls)
Jalousie Windows (crank)
Casement (cranks, levers, hinges)
Single and double-hung windows (locks and pulls)
Light switches, switch plates
Lids of laundry hampers, trash canisters, and other containers
Magazine rack
Signage
Coat rack and hooks
Shower curtain rings
Radiator cover
Bracelets
Badge clips
Name tags
Vending machines (non-food contact only)
Window sills
Electrical wall plates
Clip boards
Office supplies: paper clips, staplers, tape dispensers
Gym/Heath Club items including locker room seats or benches
Water fountains: knobs, buttons, handles, drains, push bar, basin
Restrooms: toilet flush valves, flush buttons, faucet handles, hand dryer activation buttons, soap dispenser push bar or button
Massager, hand-held: buttons, handle, knobs
Multi-surface push/pull device

### Residential Buildings (Including Homes, Apartments, Apartment Buildings and Other Residences)

Kitchen surfaces (non-food contact only): table tops, counter tops, handles (microwave, refrigerator, stove), cabinet doors, cabinet hinges, pulls, backsplash, hoods, control knobs (appliances, fans)
Bedrails, footboards
Handrails
Stair rails
Door push plates
Sinks: spigots, drains, sinks themselves
Faucet: handles, spigot, drain control lever
Paper towel holders, facial tissue holders, toilet paper holders
Door handles, doorknobs (outer touch surfaces)
Grab bars in bathrooms showers and bathtubs
Towel bars
Showerheads
Countertops and tabletops
Hinges, locks, latches, and trim
Door stops, door pulls, and protector guards
Toilet and urinal hardware, levers, push buttons
Toilet seat inlay for lifting of seat
Light switches, switch plates
Thermostat covers, control knobs and wheels
Telephone handsets and surfaces (housings), keypad
Floor tiles
Ceiling tiles (non-porous)
Wall tiles
Computer keyboards: keys, housings, computer mouse surfaces
Exercise equipment, handles, bars
Windows (crank), Locking mechanism, pull handles
Window treatments (cord pulls), Venetian blinds (wands, cord pulls)
Jalousie Windows (crank)
Casement (cranks, levers, hinges)
Single and double-hung windows (locks and pulls)
Television control knobs and buttons
Lids of laundry hampers, trash canisters, and other containers
Bedside pitchers
Closet rods and hangers
Television remote
Cup Holder
Toothbrush holder
Soap holder, dispenser
Magazine rack
Coat rack and hooks
Shower curtain rings
Radiator cover
Window sills
Electrical wallplates
Baby cribs: rails, fittings, brackets, supports
Bowl stands
Office supplies: paper clips, staplers, tape dispensers
Monitor (television, computer, etc.) housing

### Mass Transit Facilities

Handrails
Stair rails, tubular railing, and supports; elbows and brackets
Door push plates, kick plates
Door handles, door knobs (outer touch surfaces)
Grab bars and handles
Tiles: wall, floor, ceiling (non-porous)
Chairs and benches: rails, backs, legs, seats
Window sills, pulls, and handles
Signage
Vending machines (non-food contact only)
Elevator buttons

### Laboratories

Incubator interior and outside surfaces, including culture chambers, walls, shelving and support brackets, handles, circulating fan assemblies, pan
Laboratory surfaces: table tops, counter tops, handles, cabinet doors, cabinet hinges, pulls,
backsplash, hoods, control knobs
Laboratory carts, trays, and pans
Door handles, knobs, latches and locks
Laboratory equipment: safety cabinets, enclosures, vent hoods

### Other

Play area equipment (indoor only): bars, handles, chains, push plates, handrails, stair rails and risers, wheels, knobs, flooring
Chapel pews
Eye glass frames and protective eye wear
Pens
Combs
Ashtrays
Cell phones
Stylus for touch screens
Smartphone and tablet covers
Multi-surface push/pull device
Personal headphone touch surfaces
Hand-held door opening device
Bottle openers
Water fountains: knobs, buttons, handles, drains, push bar, basin
Restrooms: toilet flush valves, flush buttons, faucet handles, hand dryer activation buttons, soap dispenser push bar/button

The forming device may include a punch press, an abrasive water jet, a die, a manual shearing apparatus (e.g., scissors, or the like), a bender, or the like. The product may be made through any of the following processes, for example, but not limited to, a deep drawing process, an extrusion process, a stamping/cutting process, a cast forging process, a welding process, a brazing/etching process, or the like.

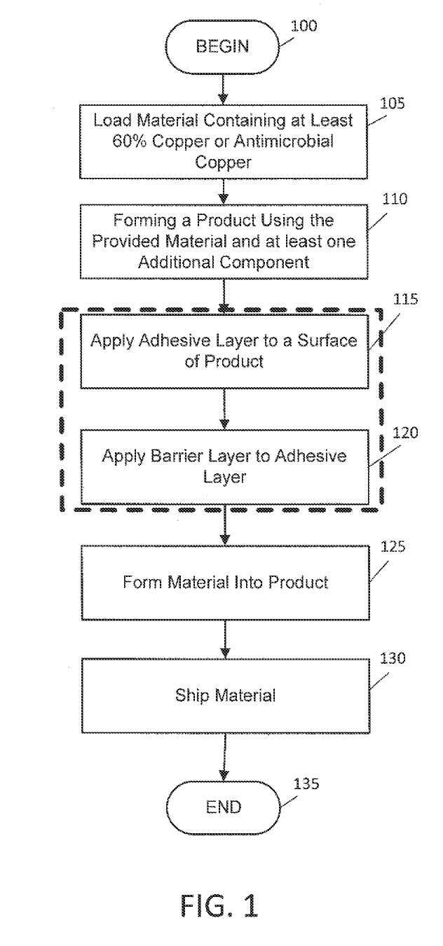

FIG. 1 shows an example of a process for manufacturing a product according to the principles of the disclosure, starting at 100. At step 105, providing or loading a material including at least 60% copper or antimicrobial copper. The material may comprise an alloy such as, e.g., including nickel and copper. In one aspect, the nickel portion may be a percentage selected from the range of about 1% to about 40% (or as any of the percentages as shown as “Other” in Table 1, Table 2 or Table 3, e.g., the nickel may be about 3.8%, about 8.7%, about 27%). The copper may be a percentage selected from a range from 60% to about 90%. At step 110 a product may be formed from the provided material using a forming device. Optionally, at step 115, an adhesive may be applied to a surface on a side (e.g., bottom side) of the product. At step 120, optionally, a barrier layer may be applied to the adhesive layer. At step 125, the material may be formed into a finished product. Alternatively, the block representing step 125 may also represent an apparatus, as described herein that is formed by step 125. Step 115 may include applying the adhesive as, e.g., the material is unrolled from a reel, or further downstream as the material travels to, e.g., a punch press. Step 120 may be done after the finished product is formed. The product may be shipped to and installed at a location, such as, e.g., a home, a business, a hospital, a retirement home, or the like.

According to an embodiment of the disclosure, the adhesive layer may be provided together with the barrier layer and the adhesive with barrier layer (or adhesive-barrier film) may be applied in a single step to the product. In this regard, the adhesive-barrier film may be rolled off a roll (not shown) and applied onto the product. The exposed adhesive side of the adhesive-barrier film may adhere to the product and the other side of the adhesive-barrier film will expose the barrier layer that may be peeled off, e.g., by the consumer at the time of installation. The adhesive-barrier film may also be applied to a free standing item or an item that is welded.

The adhesive layer may include any one or more adhesives available on the market for adhering a metal to, e.g., a metal, a wood, a plastic, a painted item, or any other surface, as is known by those skilled in the art.

The barrier layer and/or the protective layer that may cover the antimicrobial surface may include, e.g., a plastic film, or the like.

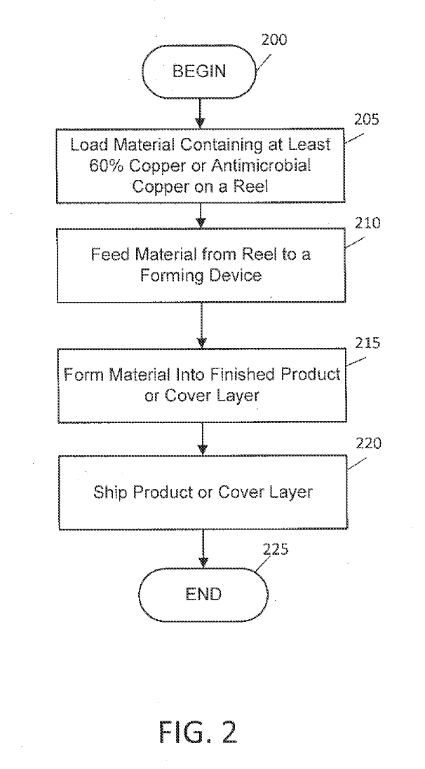

FIG. 2 is an example of a process, the steps performed according to the principles of the disclosure starting at 200. At step 205, a copper material containing at least 60% copper or antimicrobial copper may be loaded or prided on a reel. The material may include nickel in about any of the percentages as shown as “Other” in Table 1, 2 or 3 above. At step 210, the material from the reel may be fed to a forming device. At step 215, the material may be formed into a finished product. Alternatively, the material may be formed into a part of a product that has a surface that is accessible by a human touch during use. At step 220, the product may be any of the products listed herein. At step 220, the product or part thereof may be shipped for sale or installation. At 225, the process may end.

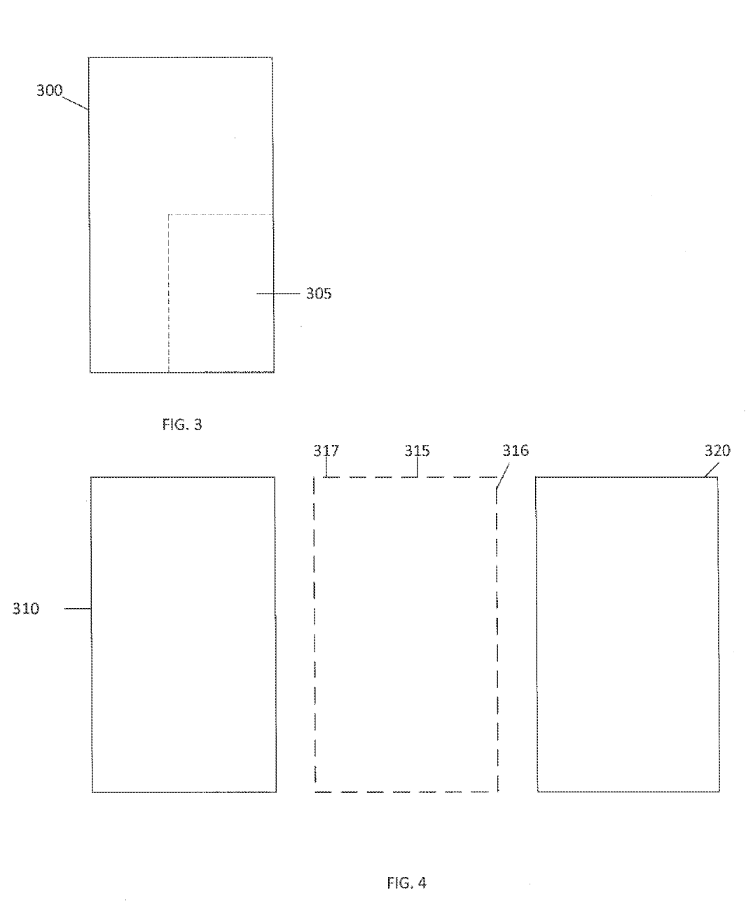

FIG. 3 is a block diagram illustrating a product or device or apparatus constructed according to principles of the disclosure. The product or device 300 or part of the device 305 may be constructed so that the device 300 illustratively represents any of the devices of products described herein comprising at least 60% copper or antimicrobial material as also described previously herein.

FIG. 4 illustrates a device 310 constructed according to principles of the disclosure. The device 310 (representing any device or product described previously herein) may be constructed with a formed layer 320 of copper or copper alloy as described herein. The formed layer 320 is shown in an unapplied state. When applied to a device 310, an antimicrobial surface for the device is created. The formed layer 320 may be constructed according to requirements of surface characteristics of the device 310 so that the formed layer 320 matches a size and/or contour of the device surface (which may be an entire surface area or a portion of the surface area). The formed layer 320 may have any number of curves or shapes. An adhesive layer 315 and one or more barrier layers 316, 317. The barrier layer 316, 317 may be removed by a user to adhere the formed copper or copper alloy layer 320 to a device 310. The formed layer 320 may comprise at least 60% copper or antimicrobial material, as described previously. The formed layer 320 may be a copper alloy as described herein.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed:

1. A antimicrobial apparatus, comprising:
a device configured with a formed antimicrobial copper layer comprising at least 60% copper.

2. The antimicrobial apparatus of claim 1, wherein the antimicrobial copper layer is a separate layer formed to match a surface contour of the device.

3. The antimicrobial apparatus of claim 2, wherein the antimicrobial copper layer is attached to the device with an adhesive layer.

4. The antimicrobial apparatus of claim 1, wherein the copper layer comprises a copper alloy.

5. The antimicrobial apparatus of claim 4, wherein the copper alloy comprise nickel.

6. The antimicrobial apparatus of claim 5, wherein the copper alloy comprises a percentage of nickel selected from the range of about 1% to about 40%.

7. The antimicrobial apparatus of claim 6, wherein the percentage of nickel is one of: about 3.8%, about 8.7%, about 27%.

8. The antimicrobial apparatus of claim 4, wherein the copper alloy comprises copper being a percentage selected from a range from 60% to about 90%.

9. The antimicrobial apparatus of claim 8, wherein the percentage of copper is one of: about 73%, about 91.3% and about 96.2%.

10. The antimicrobial apparatus of claim 1, wherein the copper layer comprises less than 99% copper.

11. The antimicrobial apparatus of claim 1, wherein the device comprises one of:
a healthcare device,
a push plate device,
a toggle switch device,
a wall plate device,
an adhesive tile device,
a sink device,
a pull device,
a bathroom device,
a water fountain device,
a doorknob,
a computer keyboard,
a kitchen device,
a handrail device,
a cart device,
a tank device,
an eyeglass device,
a dispenser device,
a thermostat device,
a home device,
an office equipment,
a bed device,
a hospital device,
television device,
a computer device,
a vending machine device,
an exercise equipment, and
a chair device.

12. A method of disinfecting or killing bacteria, the method comprising:
forming a surface for a product using EPA registered antimicrobial copper, comprising at least 60% copper.

13. The method of claim 12, further comprising shipping the formed surface to be applied to a surface of a device.

14. The method of claim 12, further comprising applying an adhesive layer to the formed surface.

15. The method of claim 12, further comprising applying the formed surface to a surface of a device.

16. The method of claim 15, wherein the device comprises one of:
a healthcare device,
a push plate device,
a toggle switch device,
a wall plate device,
an adhesive tile device,
a sink device,
a pull device, and
a bathroom device.

17. The antimicrobial apparatus of claim 15, wherein the device comprises one of:
a water fountain device,
a doorknob,
a computer keyboard,
a kitchen device,
a handrail device,
a cart device,
a tank device,
an eyeglass device, and
a dispenser device.

18. The antimicrobial apparatus of claim 15, wherein the device comprises one of:
a thermostat device,
a home device,
an office equipment,
a bed device,
a hospital device,
television device,
a computer device,
a vending machine device,
an exercise equipment, and
a chair device.

19. The method of claim 15, wherein the EPA registered antimicrobial copper comprises a copper alloy, the copper alloy comprises a percentage of nickel selected from the range of about 1% to about 40%.

20. The method of claim 19, wherein the percentage of nickel is one of: about 3.8%, about 8.7%, about 27%.
